(19) United States
(12) Patent Application Publication
(10) Pub. No.: US 2009/0126682 A1
(43) Pub. Date: May 21, 2009

(54) CONTROL APPARATUS AND METHOD FOR DIRECT INJECTION SPARK IGNITION INTERNAL COMBUSTION ENGINE

(76) Inventor: Takeshi Ashizawa, Kanagawa-ken (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/294,431

(22) PCT Filed: Oct. 15, 2007
(86) PCT No.: PCT/IB07/03057

§ 371 Date: Sep. 25, 2008

(30) Foreign Application Priority Data
Oct. 16, 2006 (JP) 2006-281595

(51) Int. Cl. F02B 3/00

(52) U.S. Cl. 123/299; 123/478

(57) ABSTRACT

In a direct injection spark ignition internal combustion engine in which, after the engine has been started at a low temperature, the tumble flow is intensified in each cylinder by the fuel injected at a time near the intake stroke bottom dead center so that homogenous combustion is properly performed and additional fuel is then injected after the ignition time in order to increase the exhaust gas temperature, the thrust force of fuel injected from a fuel injection valve is adjusted in at least two levels such that the thrust force of the additional fuel becomes weaker than the thrust force of the fuel injected at the time near the intake stroke bottom dead center.

### BACKGROUND OF THE INVENTION

1. Field of the Invention

The invention relates to a control apparatus and a control method for a direct injection spark ignition internal combustion engine.

2. Description of the Related Art

A direct injection spark ignition internal combustion engine has been proposed which, in order to accelerate the warming-up of a catalyst unit of the exhaust system of the engine after starting the engine at a low temperature, increases the exhaust gas temperature by injecting additional fuel into each cylinder on a power stroke where combustion is being performed and thus maintaining combustion in the cylinder or in the exhaust manifold on an exhaust stroke (For example, refer to Japanese Patent Application Publication No. 2000-97076 (JP-A-2000-97076)).

Meanwhile, if a tumble flow that is created in each cylinder on an intake stroke in a direct injection spark ignition internal combustion engine can be maintained until the latter half of a compression stroke by intensifying the tumble flow using the fuel injected at a time near the bottom dead center on an intake stroke (will be referred to as “intake stroke bottom dead center”), the tumble flow is smashed by the piston at the end of the compression stroke, whereby a turbulent flow is created in the cylinder at the ignition time, which enables the homogenous air-fuel mixture to be properly combusted and thereby contributes to increasing the exhaust gas temperature.

Thus, in such a direct injection spark ignition internal combustion engine, if additional fuel is injected after realizing good homogenous combustion by intensifying the tumble flow by the fuel injected at the time near the intake stroke bottom dead center as mentioned above, the exhaust gas temperature further increases and therefore the warming-up of the catalyst unit is further accelerated.

However, in order to intensify a tumble flow using the fuel injected at the time near the intake stroke bottom dead center, the thrust force of the injected fuel needs to be made relatively strong. When the thrust force is strong, it is difficult, in view of the performance of the fuel injection valve, to inject only a small amount of fuel as the foregoing additional fuel after the ignition time. If fuel more than a given necessary amount is injected as the foregoing additional fuel, part of the injected additional fuel is not properly combusted, which may lead to the production of smoke or an increase in the amount of unburned fuel.

### SUMMARY OF THE INVENTION

The inventions provides a control apparatus and a control method for a direct injection spark ignition internal combustion engine in which, after the engine has been started at a low temperature, a tumble flow is intensified in each cylinder by the fuel injected at a time near the intake stroke bottom dead center so that homogenous combustion is properly performed, and additional fuel is then injected after the ignition time in order to increase the exhaust gas temperature. The control apparatus and method of the invention suppress the production of smoke and an increase in the amount of unburned fuel by preventing the injection amount of the additional fuel from exceeding the necessary amount.

A first aspect of the invention relates to a control apparatus for a direct injection spark ignition internal combustion engine, which, after starting the direct injection spark ignition internal combustion engine at a low temperature, intensifies a tumble flow by injecting fuel from a fuel injection valve, which is arranged to inject fuel directly into a cylinder, at a time near an intake stroke bottom dead center, and injects additional fuel from the fuel injection valve after an ignition time, wherein the thrust force of fuel injected from the fuel injection valve is adjustable in at least two levels, and the thrust force of the additional fuel is made weaker than the thrust force of the fuel injected at the time near the intake stroke bottom dead center.

The thrust force of the fuel injected from the fuel injection valve at the time near the intake stroke bottom dead center needs to be made strong to intensify the tumble flow. If the additional fuel is injected with the same thrust force, a relatively large amount of fuel is injected as the additional fuel, that is, fuel exceeding the foregoing necessary amount will be injected as the additional fuel even if the valve-open duration of the fuel injection valve is set to the minimum valve-open duration, and this may lead to the production of smoke and an increase in the amount of unburned fuel. Therefore, in order to prevent the injection amount of additional fuel from exceeding the necessary amount, the above-described control apparatus of the first aspect of the invention adjusts the thrust force of fuel injected from the fuel injection valve in at least two levels such that the thrust force of the additional fuel injected after the ignition time becomes weaker than the thrust force of the fuel injected at the time near the intake stroke bottom dead center.

A second aspect of the invention relates to a control method for controlling a direct injection spark ignition internal combustion engine having a fuel injection valve that injects fuel directly into a cylinder. In this control method, a tumble flow is intensified by injecting fuel from the fuel injection valve at a time near an intake stroke bottom dead center after starting the direct injection spark ignition internal combustion engine at a low temperature, and additional fuel is injected from the fuel injection valve after an ignition time. The fuel injection valve adjusts the thrust force of injected fuel in at least two levels, and the thrust force of the additional fuel is made weaker than the thrust force of the fuel injected at the time near the intake stroke bottom dead center.

### BRIEF DESCRIPTION OF THE DRAWINGS

The above and other features of the present invention will become apparent from the following description of embodiments given in conjunction with the accompanying drawings, in which:

FIG. 1 is a vertical cross-sectional view schematically showing the structure of each cylinder of a direct injection spark ignition internal combustion engine that is controlled by a control apparatus according to an exemplary embodiment of the invention;

FIG. 2 is a timechart indicating the lift of the fuel injection valve after cold engine start;

FIG. 3 is a cross-sectional view schematically showing the structure of the lower end portion of the fuel injection valve; and

FIG. 4A and FIG. 4B are views each schematically showing the structure for adjusting the lift of the valve element of the fuel injection valve.

### DETAILED DESCRIPTION OF EMBODIMENTS

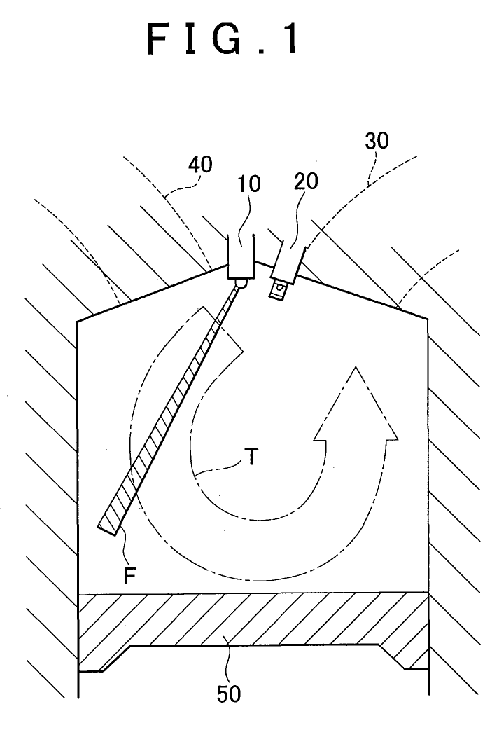

FIG. 1 is a vertical cross-sectional view schematically showing the structure of each cylinder of a direct injection spark ignition internal combustion engine that is controlled by a control apparatus according to an exemplary embodiment of the invention. Specifically, FIG. 1 shows a state immediately before the intake stroke bottom dead center on an intake stroke, which corresponds to the time of fuel injection for homogenous combustion. Referring to FIG. 1, a fuel injection valve 10 is provided at substantially the center of the upper area of the cylinder to inject fuel directly into the cylinder, and an ignition plug 20 is provided near the fuel injection valve 10 on the intake valve side thereof. FIG. 1 also shows a pair of intake ports 30 communicating with the inside of the cylinder via a pair of intake valves (not shown in the drawings), a pair of exhaust ports 40 communicating with the inside of the cylinder via a pair of exhaust valves (not shown in the drawings) and, a piston 50.

In the direct injection spark ignition internal combustion engine of the exemplary embodiment, fuel is directly injected into each cylinder at a time near the intake stroke bottom dead center (For example, the crank angle at which to start fuel injection is set based on the fuel injection amount such that the fuel injection will end at a crank angle near the intake stroke bottom dead center, or the crank angle at which to start fuel injection is set to the latter half of each intake stroke irrespective of the fuel injection amount) such that a homogenous air-fuel mixture is formed at the ignition time that comes at the end of the compression stroke. This homogenous air-fuel mixture is ignited by a spark, whereby homogenous combustion is performed.

The fuel injection valve 10, as shown in FIG. 1, injects fuel F obliquely downward toward the exhaust valve side of the cylinder bore (preferably to the lower portion of the exhaust valve side of the cylinder bore). The thrust force of the fuel F injected from the fuel injection valve 10 is set such that the front of the injected fuel F reaches the point at least 60 mm away from the injection hole 1 msec after the beginning of the fuel injection.

As the injected fuel F having such a large thrust force moves obliquely downward from substantially the center of the upper area of the cylinder toward the exhaust valve side of the cylinder bore, the thrust force of the injected fuel F intensifies a tumble flow T that has been created in the cylinder and is flowing downward in the exhaust valve side of the cylinder and upward in the intake valve side. The tumble flow T thus intensified is reliably maintained until the latter half of the compression stroke and then smashed by the piston 50, whereby a turbulent flow is created in the cylinder. Therefore, if the air-fuel mixture is ignited at the end of the compression stroke, homogenous combustion progresses at a high speed and in a good condition.

The shape into which fuel F is injected may be arbitrarily selected from among various shapes. For example, using a single injection hole, the fuel F can be injected into, for example, the shape of a solid or hollow cone. Further, using a slit-shaped injection hole, the fuel F can be injected into a relatively thin fan-like shape. Further, using an arc-slit-shaped injection hole, the fuel F can be injected into a relatively thin arc shape, the convex side of which faces the upper side and the exhaust valve side. Further, using a combination of two or more straight-slit-shaped injection holes, the fuel F can be injected into an angular shape. In short, the fuel F may be injected into any shape as long as the thrust force of the injected fuel F can be made large enough to accelerate the tumble flow T in the cylinder.

In the direct injection spark ignition internal combustion engine of this exemplary embodiment, because the ignition plug 20 is provided on the intake valve side of the fuel injection valve 10, the ignition plug 20 is not moistened by the fuel that has been injected from the fuel injection valve 10 toward the exhaust valve side of the cylinder bore, and therefore the ignition plug 20 can appropriately generate electric arcs at the ignition time.

In the direct injection spark ignition internal combustion engine of this exemplary embodiment, in order to save the fuel consumption, the air-fuel ratio for homogenous combustion is set to a ratio that is leaner than the stoichiometric air-fuel ratio (preferably 20 or more, which suppresses the production of NOx), and therefore homogenous combustion tends to progress slowly. Thus, it is especially advantageous to increase the combustion speed as mentioned above. Meanwhile, the air-fuel ratio for homogenous combustion may alternatively be set to the stoichiometric air-fuel ratio or to a rich air-fuel ratio. In this case, too, increasing the combustion speed provides various advantages.

After cold engine start, that is, after starting the internal combustion engine when the engine temperature, which is typically known from the coolant temperature, was equal to or less than a set temperature, it is necessary to quickly warm up a catalyst unit (e.g., three way catalyst unit and NOx adsorption-reduction catalyst unit), which is provided in the exhaust system of the internal combustion engine, to its activation temperature so that the catalyst unit starts purifying the exhaust gas as soon as possible. For this purpose, the control apparatus of this exemplary embodiment executes a specific heating control in the direct injection spark ignition internal combustion engine, as described below. Note that, upon engine start including cold engine start, in order to improve the ignitability, the air-fuel ratio of homogenous air-fuel mixtures is preferably set to the stoichiometric air-fuel ratio or to a rich air-fuel ratio.

In the first heating control, the ignition time that is set at the end of each compression stroke during the normal operation state is retarded to after the top dead center on the compression stroke (will be referred to as “compression stroke top dead center”). The later the ignition time, the later the end of combustion. Therefore, as the ignition time is retarded, the temperature of the exhaust gas discharged from each cylinder increases. In the direct injection spark ignition internal combustion engine described above, a turbulent flow is created in each cylinder by a strong tumble flow before the compression stroke top dead center, and the turbulent flow is maintained until after the compression stroke top dead center. Therefore, even if the ignition time is retarded to after the compression stroke top dead center, the homogenous air-fuel mixture can be combusted properly.

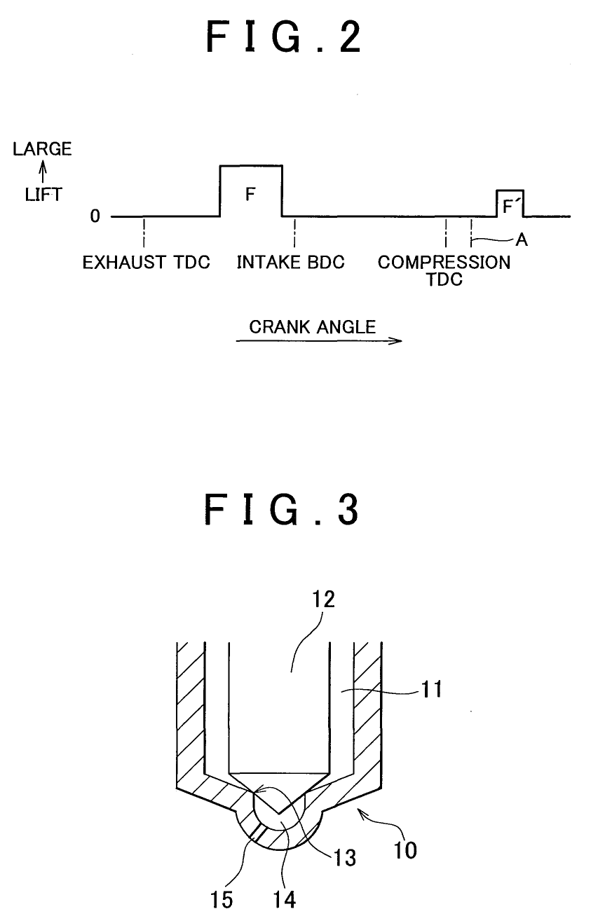

In the second heating control, as shown in FIG. 2, additional fuel F′ is injected from the fuel injection valve 10 while the homogenous air-fuel mixture formed by the fuel F that was injected at a time near the intake bottom dead center is being combusted. The time for injecting this additional fuel F′ is not limited to power strokes, but it may be set to exhaust strokes. Thus injected after the ignition time A, the additional fuel F′ is combusted in the cylinder in the latter half of the power stroke or on the exhaust stroke, or it is combusted outside of the cylinder (e.g., in the exhaust manifold) on the exhaust stroke, whereby the temperature of the exhaust gas entering the catalyst unit further increases. As such, the warming-up of the catalyst unit can be accelerated.

In the direct injection spark ignition engine of this exemplary embodiment, because the additional fuel F′ is injected from the fuel injection valve 10 toward the exhaust value side of the cylinder, the injected additional fuel F′ tends to be discharged to the outside of the cylinder on the exhaust stroke and then combusted, which contributes to increasing the temperature of the exhaust gas entering the catalyst unit.

The necessary amount of the additional fuel F′ is small. If fuel more than this small necessary amount is injected as the additional fuel F′, smoke may be produced due to incomplete fuel combustion or the amount of unburned fuel may increase. Because the fuel injection valve 10 is arranged to inject fuel with a strong thrust force in order to intensify tumble flows, if the additional fuel F′ is injected with the same thrust force, the injection amount of the additional fuel F′ will exceed the foregoing necessary amount even if the valve-open duration of the fuel injection valve 10 is set to the minimum valve-open duration that is determined by the performance of the fuel injection valve 10.

In order to solve this problem, the control apparatus of this exemplary embodiment adjusts the thrust force of the fuel injected from the fuel injection valve 10 in at least two levels such that the thrust force of the fuel that is injected at a time near the intake stroke bottom dead center to intensify the tumble flow T is strong while the thrust force of the fuel that is injected after the ignition time is weak. Thus, when injecting the additional fuel F′, because the fuel thrust force is weakened, the necessary amount of fuel can be reliably injected by a valve-open duration that is equal to or longer than the minimum valve-open duration.

The thrust force of the fuel injected from the fuel injection valve 10 can be adjusted in two levels by, for example, controlling the lift of the valve element of the fuel injection valve 10 in two levels. FIG. 3 is a cross-sectional view showing the lower end portion of the fuel injection valve 10. Referring to FIG. 3, a fuel passage 11 is provided in the fuel injection valve 10, which extends in the axial direction of the fuel injection valve 10, and a valve element 12 is provided in the fuel passage 11, which is movable in the axial direction of the fuel injection valve 10. A fuel sump 14 is formed downstream of a seat portion 13 that contacts the seal portion of the valve element 12. An injection hole 15 is formed such that the fuel sump 14 communicates with the outside through the injection hole 15.

In the fuel injection valve 10 configured as described above, when the valve element 12 has been lifted up and thus the seal portion of the valve element 12 and the seat portion 13 have moved apart from each other, the high pressure oil in the fuel passage 11 is supplied into the fuel sump 14, and when the pressure of the fuel in the fuel sump 14 has exceeded the pressure in the cylinder, the fuel is injected from the fuel sump 14 through the injection hole 15. On the other hand, when the seal portion of the valve element 12 comes into contact with the seat portion 13, the fuel supply from the fuel passage 11 to the fuel sump 14 is interrupted, whereby the pressure of the fuel in the fuel sump 14 decreases, and when the pressure of the fuel in the fuel sump 14 has become lower than the pressure in the cylinder, the fuel injection from the injection hole 15 stops.

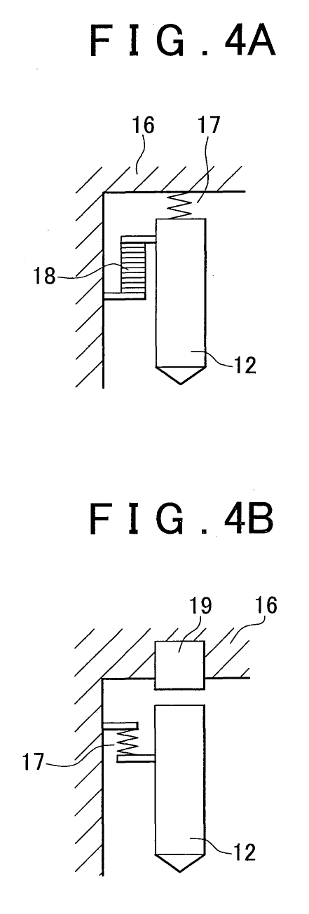

The fuel injection valve 10 is structured such that its lift can be adjusted in at least two levels, as schematically illustrated in FIG. 4A and FIG. 4B, respectively. In the structure illustrated in FIG. 4A, the valve element 12 is urged in the valve closing direction by a valve-close spring 17 that is provided between the valve element 12 and a valve main body 16. A piezoelectric strain actuator (piezo actuator) 18 is also provided between the valve element 12 and the valve main body 16. As the piezoelectric strain actuator 18 extends, the valve element 12 moves upward, whereby the fuel injection valve 10 opens. Thus, the lift of the valve element 12 can be adjusted in two levels (i.e., between a large lift and a small lift) by adjusting the extension of the piezoelectric strain actuator 18 in two levels by controlling the voltage supplied to the piezoelectric strain actuator 18 in two levels.

On the other hand, in the structure shown in FIG. 4B, the valve element 12 is urged by the valve-close spring 17 that is provided between the valve element 12 and the valve main body 16, and an electromagnetic actuator (solenoid actuator) 19 is provided in the fuel injection valve main body 10. The electromagnetic actuator 19 is arranged to face the base portion of the valve element 12 so that the electromagnetic attracting force of the electromagnetic actuator 19 acts in the direction to lift the valve element 12 up, that is, in the direction to open the fuel injection valve 10. As such, the lift of the valve element 12 can be adjusted in two levels (i.e., between a large lift and a small lift) by adjusting the electromagnetic attracting force acting on the valve element 12 in two levels by controlling the voltage supplied to the electromagnetic actuator 14 in two levels.

The control apparatus of the exemplary embodiment controls the lift of the valve element 12 of the fuel injection valve 10 configured as described above such that, as shown in FIG. 2, the valve element 12 is lifted up by a large lift when injecting the fuel F at a time near the intake stroke bottom dead center and the valve element 12 is lifted up by a small lift when injecting the additional fuel F′ after the ignition time. The smaller the lift of the valve element 12, the narrower the clearance between the valve element 12 and the seat portion 13 becomes when the valve element 12 is lifted up, and therefore the pressure loss at the clearance increases and thus the pressure of the fuel injected from the fuel sump 14 decreases. As such, if the valve element 12 is lifted by the small lift, the thrust force of the fuel injected from the injection hole 15 is weak, and if the valve element 12 is lifted by the large lift, the thrust force of the fuel injected from the injection hole 15 is strong.

The control apparatus of the exemplary embodiment executes the first heating control and the second heating control in combination as described above. However, the first heating control may be omitted by not retarding the ignition time A and but setting it to before the compression stroke bottom dead center. In this case, too, due to the turbulent flow in the cylinder, the homogenous air-fuel mixture can be combusted properly, and therefore the temperature of the exhaust gas becomes high. In this case, therefore, the exhaust gas temperature can be increased relatively effectively by executing the second heating control for injecting additional fuel after the ignition time (preferably on the compression stroke or on the power stroke).

In the direct injection spark ignition internal combustion engine described above, in order to intensify tumble flows, the fuel injection valve 10 is provided at substantially the center of the upper area of the cylinder such that the fuel injection valve 10 injects fuel obliquely downward the exhaust valve side of the cylinder bore. However, the fuel injection valve 10 may alternatively be provided at the exhaust valve side of the periphery of the upper area of the cylinder such that the fuel injection valve 10 injects fuel substantially straight downward toward the exhaust valve side of the cylinder, or the fuel injection valve 10 may alternatively be provided at the intake valve side of the periphery of the upper area of the cylinder such that the fuel injection valve 10 injects fuel toward the upper portion of the exhaust valve side of the cylinder bore. In either case, tumble flows can be intensified by injecting fuel at a time near the intake stroke bottom dead center.

1-10. (canceled)

11. A control apparatus for a direct injection spark ignition internal combustion engine comprising:
in which, after starting the direct injection spark ignition internal combustion engine at a low temperature, intensifies a tumble flow by injecting fuel from a fuel injection valve, which is arranged to inject fuel directly into a cylinder, at a time near an intake stroke bottom dead center, and injects additional fuel from the fuel injection valve after an ignition time, and
the thrust force of fuel injected from the fuel injection valve is adjustable in at least two levels, and the thrust force of the additional fuel is made weaker than the thrust force of the fuel injected at the time near the intake stroke bottom dead center.

12. The control apparatus according to claim 11, wherein the thrust force of fuel is adjusted by adjusting the lift of a valve element of the fuel injection valve.

13. The control apparatus according to claim 12, wherein the lift of the valve element that is set when injecting the additional fuel is smaller than the lift of the valve element that is set when injecting the fuel at the time near the intake stroke bottom dead center.

14. The control apparatus according to claim 12, wherein:
the fuel injection valve includes: an elastic member that is provided between the valve element of the fuel injection valve and a main body of the fuel injection valve and urges the valve element in a valve-closing direction; and a piezoelectric strain actuator that is provided between the valve element of the fuel injection valve and the main body of the fuel injection valve and extends to lift the valve element up; and
the lift of the valve element is adjusted by changing the extension of the piezoelectric strain actuator by controlling the voltage supplied to the piezoelectric strain actuator.

15. The control apparatus according to claim 12, wherein:
the fuel injection valve includes: an elastic member that is provided between the valve element of the fuel injection valve and a main body of the fuel injection valve and urges the valve element in a valve-closing direction; and an electromagnetic actuator that is arranged to face a base portion of the valve element so that an electromagnetic attracting force of the electromagnetic actuator acts in a direction to lift the valve element up; and
the lift of the valve element is adjusted by changing the electromagnetic attracting force acting on the valve element by controlling the voltage supplied to the electromagnetic actuator.

16. The control apparatus according to claim 11, wherein the additional fuel is injected from the fuel injection valve toward the exhaust valve side in the cylinder.

17. The control apparatus according claim 11, wherein the additional fuel is injected on a power stroke or on an exhaust stroke.

18. The control apparatus according to claim 11, wherein after starting the direct injection spark ignition internal combustion engine at a low temperature, the control apparatus executes a first heating control that retards the ignition time to after a compression stroke top dead center and a second heating control that injects the additional fuel from the fuel injection valve after the ignition time.

19. The control apparatus according to claim 13, wherein:
the fuel injection valve includes: an elastic member that is provided between the valve element of the fuel injection valve and a main body of the fuel injection valve and urges the valve element in a valve-closing direction; and a piezoelectric strain actuator that is provided between the valve element of the fuel injection valve and the main body of the fuel injection valve and extends to lift the valve element up; and
the lift of the valve element is adjusted by changing the extension of the piezoelectric strain actuator by controlling the voltage supplied to the piezoelectric strain actuator.

20. The control apparatus according to claim 13, wherein:
the fuel injection valve includes: an elastic member that is provided between the valve element of the fuel injection valve and a main body of the fuel injection valve and urges the valve element in a valve-closing direction; and a electromagnetic actuator that is arranged to face a base portion of the valve element so that an electromagnetic attracting force of the electromagnetic actuator acts in a direction to lift the valve element up; and
the lift of the valve element is adjusted by changing the electromagnetic attracting force acting on the valve element by controlling the voltage supplied to the electromagnetic actuator.

21. A control method for controlling a direct injection spark ignition internal combustion engine having a fuel injection valve that injects fuel directly into a cylinder, comprising:
intensifying a tumble flow by injecting fuel from the fuel injection valve at a time near an intake stroke bottom dead center after starting the direct injection spark ignition internal combustion engine at a low temperature; and
injecting additional fuel from the fuel injection valve after an ignition time,
wherein the fuel injection valve adjusts the thrust force of injected fuel in at least two levels, and the thrust force of the additional fuel is made weaker than the thrust force of the fuel injected at the time near the intake stroke bottom dead center.

22. The control method according to claim 21, wherein the lift of the valve element of the fuel injection valve that is set when injecting the additional fuel is smaller than the lift of the valve element that is set when injecting the fuel at the time near the intake stroke bottom dead center.
